(19) United States
(12) Patent Application Publication
(10) Pub. No.: US 2014/0013237 A1
(43) Pub. Date: Jan. 9, 2014

(54) Extensible Framework to Expose Metametadata for Dynamically Generated User Interfaces

(71) Applicants: Avrom Roy-Faderman, Sunnyvale, CA (US); Barathkumar Sundaravaradan, San Francisco, CA (US); Carolyn Grabill, San Francisco, CA (US); Cordelia McGee-Tubb, San Francisco, CA (US); Durgashankar Giridharan, San Francisco, CA (US); Edward li, Alameda, CA (US); Andrew Tran, San Francisco, CA (US); Luc Giavelli, San Francisco, CA (US); Sadiya Hameed, San Francisco, CA (US); Simon Wong, San Carlos, CA (US)

(72) Inventors: Avrom Roy-Faderman, Sunnyvale, CA (US); Barathkumar Sundaravaradan, San Francisco, CA (US); Carolyn Grabill, San Francisco, CA (US); Cordelia McGee-Tubb, San Francisco, CA (US); Durgashankar Giridharan, San Francisco, CA (US); Edward li, Alameda, CA (US); Andrew Tran, San Francisco, CA (US); Luc Giavelli, San Francisco, CA (US); Sadiya Hameed, San Francisco, CA (US); Simon Wong, San Carlos, CA (US)

(21) Appl. No.: 13/934,550

(22) Filed: Jul. 3, 2013

Related U.S. Application Data
(60) Provisional application No. 61/667,808, filed on Jul. 3, 2012.

(51) Int. Cl. G06F 3/048

(52) U.S. Cl. CPC G06F 3/048
USPC 715/744

(57) ABSTRACT

An extensible framework for exposing metametadata for use in generating a graphical user interface.

### TECHNICAL FIELD

Embodiments relate to techniques for providing custom interfaces. More particularly, embodiments relate to techniques for utilizing information about metadata, or metametadata, to provide custom interfaces.

### BACKGROUND

Graphical interfaces are used in many different environments to provide information to users of electronic devices and to allow the users of electronic devices to enter or alter information themselves. The information can be, for example, settings for a device, organizational data, atmospheric conditions, etc. To provide a graphical interface, metadata, or information about data, is commonly utilized to support the interface. This is particularly true of dynamic interfaces.

### BRIEF DESCRIPTION OF THE DRAWINGS

The invention is illustrated by way of example, and not by way of limitation, in the figures of the accompanying drawings in which like reference numerals refer to similar elements.

FIG. 1 is an example user interface that can be utilized to create a new custom field of type Number using metametadata as described herein.

FIG. 2 is a conceptual illustration of a mapping of properties to metametadata for an example custom field.

FIG. 3 illustrates a text field creation window in which information not in the underlying metadata can be used to provide information not available in the underlying metadata.

FIG. 4 is a conceptual illustration of calls a client might make to prepare for displaying a user interface to edit or display metadata for a custom field.

FIG. 5 is a conceptual illustration of a set of calls a client could use upon receiving user information for the user interface displayed in FIG. 4.

FIG. 6 is a block diagram of one embodiment of a computer system.

FIG. 7 is a block diagram of one environment wherein an on-demand database service might be used.

FIG. 8 is a block diagram of one embodiment of elements of environment of FIG. 7 and various possible interconnections between these elements.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

The techniques described herein are useful, for example, when creating a user interface for editing metadata such as a custom entity object. The process of loading and saving the metadata can be accomplished using metadata mechanisms in most cases. However there is a variety of “metametadata” or information about the type of metadata that is to be displayed, saved or otherwise utilized.

Information such as what properties should be marked as required, what labels should be used for user interface (UI) widgets, the structure of each property (e.g., text, Boolean, number), or whether the property is editable can be maintained as metametadata. This information can be dynamic, depending on the specific metadata being displayed/utilized and/or based on information about the user. For example, the length of a text field may be editable only if the text field is not released in a managed package, and whether a field is part of an index may be editable only if the user or their organization as a particular corresponding permission in a multi-tenant database system.

Fields that are to be displayed in the UI may not map to the structure of the underlying metadata in a one-to-one manner. For example, scale and precision information may be stored for numeric fields as metadata, but the user may not be allowed to enter precision directly. Some UI or framework developers may wish to expand a base system, for example, by adding properties or information about he properties that are available. For example, a base system may not include information about calling Javascript because not all clients may be implemented in a HTML/Javascript language. For clients that do use HTML/Javascript languages it may be useful to be able to extend the base properties to automatically add metametadata about Javascript calls.

In one embodiment, a set of UI properties may not map to the structure of the underlying metadata in an underlying manner. For example, a user may not be allowed to enter a precision directly, but instead may be allowed to enter something else that is use to calculate the precision, even though that precision, but not the something else, is on the underlying metadata. A UI or framework developer may wish to expand the base system to provide additional properties.

As another example, individual UI properties that do map to individual properties of the underlying metadata may be altered in some way. A property that corresponds to a Boolean could instead be mapped to different metadata.

In various embodiments, one or more of the following four mechanisms can be employed to provide dynamically generated UIs utilizing metametadata. In one embodiment, there is provided a service that, given a key (e.g., an identifier) to a metadata object, can return a bundle of properties appropriate to that object. Some of these properties can be mapped to underlying properties of the metadata object; other properties can be calculated.

For example, a service can be used to pass a field ID or an entity ID to get a bundle of properties appropriate to display a UI for editing the metadata of the field and/or entity. As another example, an entity ID and a field type can be passed to get a bundle of properties appropriate for creating a new field of that field type on that entity. The properties in the bundle can depend on the entity, field type, field managed state, and/or current user's permissions. Different properties as well as a different number of properties can also be utilized. In one embodiment, properties can be direct wrappers for underlying object metametadata or can be implemented using, for example, Java® code that reads and processes the object in a specialized manner.

In one embodiment, there is provided a mechanism that associates the property bundles with existing object metadata (e.g., for display) and can also map property bundles back to the original metadata (e.g., for processing form submissions). In one embodiment, there is provided a mechanism for wrapping the properties to add more information or override the information provided, and/or a way to add entirely new properties. In one embodiment, one or more of these mechanisms can be utilized to wrap properties in a way that allows creation of, for example, custom Javascript-powered UIs with the look and feel of standard UIs for editing the underlying object(s).

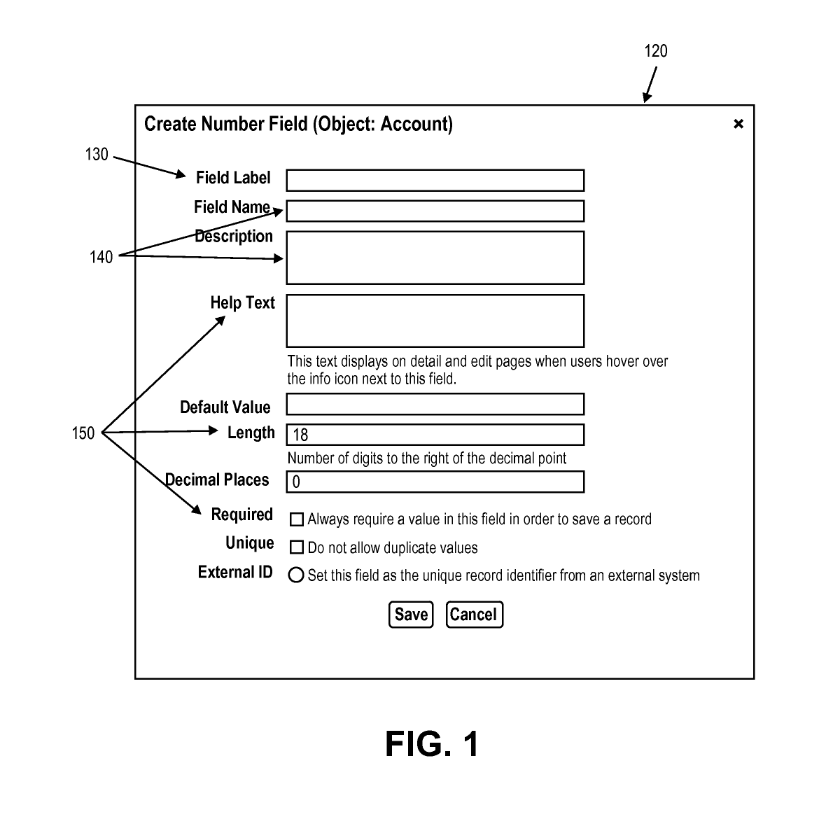

FIG. 1 is an example user interface that can be utilized to create a new custom field of type Number using metametadata as described herein. In the example of FIG. 1, window 120 allows a user to create a new number field within a custom UI, which may be used, for example, by a tenant of a multitenant database system.

In the example of FIG. 1, the new field has associated labels (e.g., 130) that are part of the properties included in the metadata provided for the object. Continuing the new number field example, the labels can be a field label, a field name, a description, help text, a default value, a length, a number of decimal places allowed and/or other information (whether the field is required, whether duplicate values are allowed, and/or if there can be an external identifier). A different set of labels can also be supported. The labels that are editable and/or accessible can vary based on, for example, a user's privilege level or organization/tenant.

In one embodiment, some properties are required while other properties are optional. In the example of FIG. 1, the field label, field name, length and decimal places are required properties, while the remaining properties are optional. In the example of FIG. 1, a thicker bar on the left side of a field indicates required fields. Fields 140 include one required field (field name) and one optional field (description). Other configurations can also be supported.

The type of property (e.g., Boolean, which can be rendered as a check box, or a number, or freeform text, or a selection from a list of values) is another piece of information that the properties can provide. Fields 150 include a freeform text area property, a number property and a Boolean property, respectively.

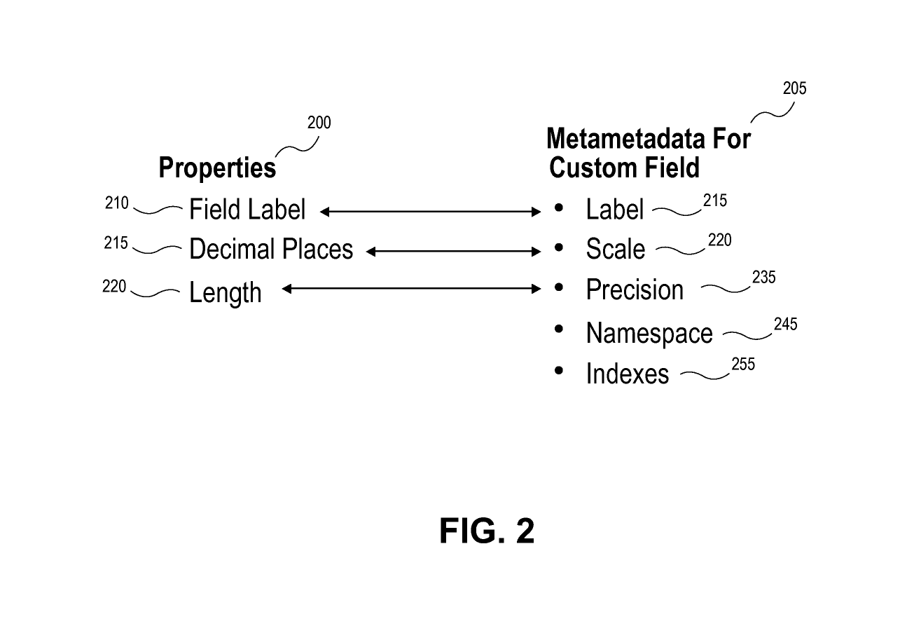

FIG. 2 is a conceptual illustration of a mapping of properties to metametadata for an example custom field. Properties 200 do not necessarily map to underlying metametadata 205 in a one-to-one manner. In the example of FIG. 2, Field Label property 210 and Decimal Places property 215 can map directly to corresponding metametadata fields Label and Scale 220.

In the example of FIG. 2, Length property 230 does not map directly to Precision metametadata field 235 in a one-to-one manner. For example, length can be precision minus scale (i.e., the value in precision custom field 235 minus the value in scale custom field 220) and precision can be length plus decimal places (i.e., a number having a length defined by length property 220 and decimal places property 215.

In one embodiment, Namespace field 245 may not be editable by users and may not be used for a new custom field. Indexes field 255 represents fields that are not available to all tenants of a multitenant database system and may only appear on certain tenant's visible property list.

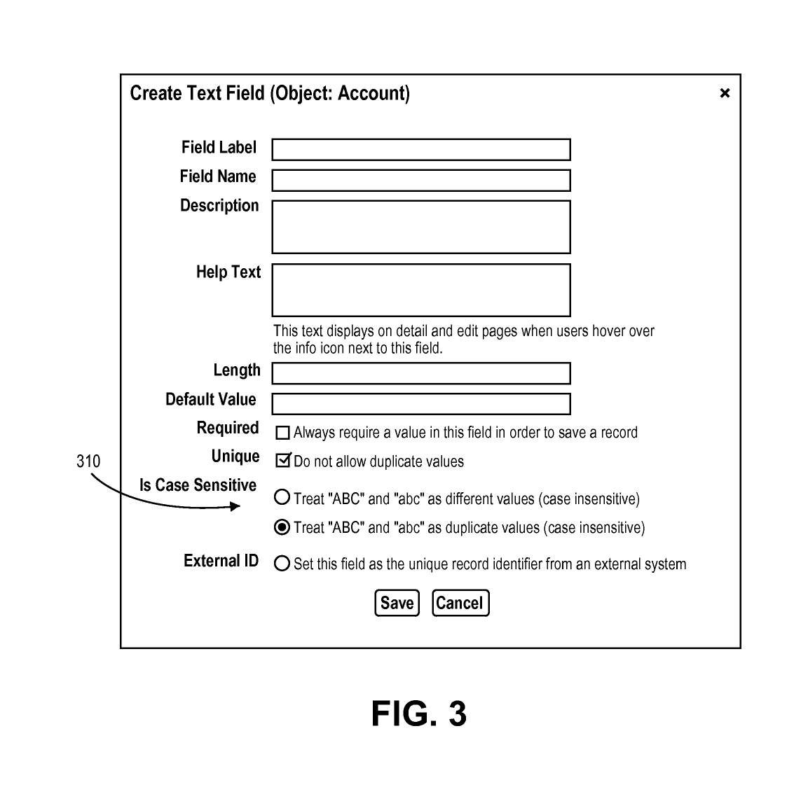

FIG. 3 illustrates a text field creation window in which UI properties can provide information not in the underlying metadata properties. In the example of FIG. 3, the underlying property (e.g., whether a field is case sensitive) 310, is a Boolean value, but can be treated as an enumeration so that information can be provided for each option. In the case sensitivity example of FIG. 3, case sensitivity causes the values in the field to be treated as different values, or as duplicate values.

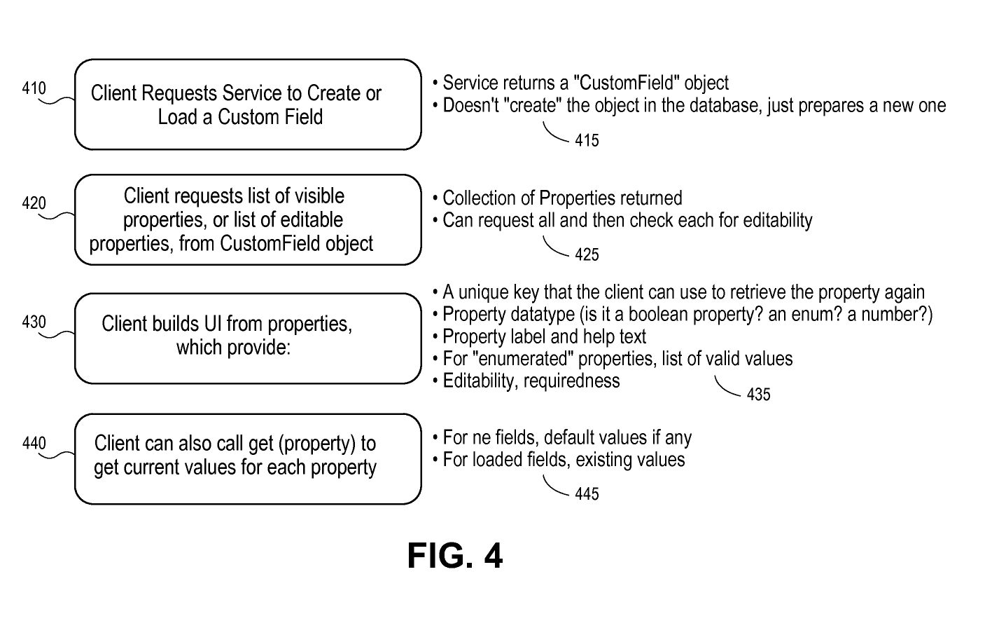

FIG. 4 is a conceptual illustration of client calls that allow it to create a user interface for creating, editing, or displaying metadata for a custom field. The example of FIG. 4 is but one use of the custom fields and metametadata discussed herein. As mentioned above, the custom fields and metametadata have many applications beyond the examples included herein.

In one embodiment, the client requests the Service object to create or load a custom field, 410. The Service object can return a “CustomField” object and may not create the object in the database, but prepares a new CustomField, 415. The client can then request a list of visible properties, or a list of editable properties, from the CustomField object, 420. The CustomField object can then return a collection of properties, 425. The client can request all properties and check each for editability.

The client builds the user interface from the properties, 430. In one embodiment, each property, 435, includes one or more of: a unique key that the client can use to retrieve the property again; a property datatype; a property label and/or help text; for enumerated properties, a list of valid values; and/or editability and/or requiredness for one or more properties. Other properties and/or different groupings of properties can also be supported.

In one embodiment, the client can also perform a get(property) on the CustomField to get current values for each property, 440. In one embodiment, for new fields default values (if any) can be provided, or for loaded fields existing values can be provided, 445.

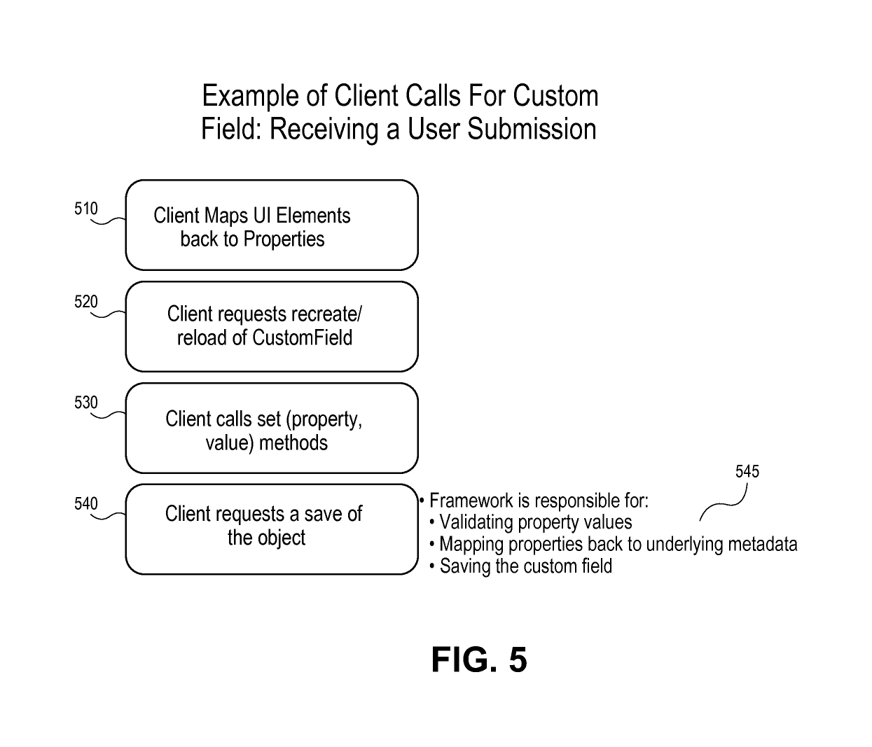

FIG. 5 is a conceptual illustration of a set of client calls to save custom field metadata submitted by the user. The example of FIG. 5 is but one use of the custom fields and metametadata discussed herein. As mentioned above, the custom fields and metametadata have many applications beyond the examples included herein.

In one embodiment, the client object maps UI elements back to properties (e.g., the properties of FIG. 4), 510. The client can request a recreate/reload of one or more CustomFields, 520. In one embodiment, the client object can then call set (property,value) methods, 530.

The client can request a save of the custom object, 540. In one embodiment, in response to a save request, the framework can be responsible for validating property values, mapping properties to underlying metadata and/or saving the custom field, 545.

In one embodiment, the client object can create a “Property Provider” object. In one embodiment, the Property Provider specifies a “source” property type (e.g., the generic Property type, or a subtype of that type); a “result” property type (e.g., a specific subtype of Property, which is generally provided by the client); and/or a method that accepts properties of the source type and returns properties of the result type (e.g., returned property shares the “unique key” with the underlying property).

The following is an example use of a Property Provider. Specifically, the example is directed to a basic property enhancement called HTML-UI-Property-Provider that is of the generic “Property” type. The result type is HTML-UI-Property, which is described in greater detail below. In one embodiment, the HTML-UI-Property-Provider gets a unique key from the underlying property. The HTML-UI-Property-Provider can look up the unique key in a map to obtain additional information. In one embodiment, HTML-UI-Property-Provider creates HTML-UI-Property using the additional information and the underlying property/properties.

In one embodiment, HTML-UI-Property wraps the underlying property and delegates one or more methods to it. In one embodiment, HTML-UI-Property may include additional information. The additional information can be, for example, a Java Script Controller (jsController) that can be, for example, a URI for a Java Script class that handles various Java Script events for the element (e.g., implements a specified interface which the client can call from the elements' Java Script handlers). The additional information can be, for example, a display property (e.g., displayAsRadio: For enum elements, whether they should be displayed as a radio button group rather than a dropdown list). The additional information can be, for example, is disabled condition that can be, for example, a Java Script expression to evaluate; if true on page load the field is initially rendered as disabled. Other additional information can also be supported.

In one embodiment the multitenant database environment provides functionality to “compose” Property Providers. In one embodiment, if the result type of Property Provider A is equal to, or a subtype of, the source type of Property Provider B, the user is allowed to “compose” A and B. In one embodiment, the result type has A's source type and B's target type. The method first applies A's method, then applies B's method to the result.

In one embodiment, providers can be chained. For example, a particular client can make a property provider with the source type HtmlUiProperty. This can be composed with HtmlUiPropertyProvider. The composition has generic source type, result type tailored to the particular client.

In one embodiment, when a custom field is created or loaded a provider can be specified. In one embodiment, the source type has to be the generic “Property” type. In one embodiment, the resulting CustomField object returns properties that have been passed through the provider. In one embodiment, the provider will also accept these property types for get and set methods.

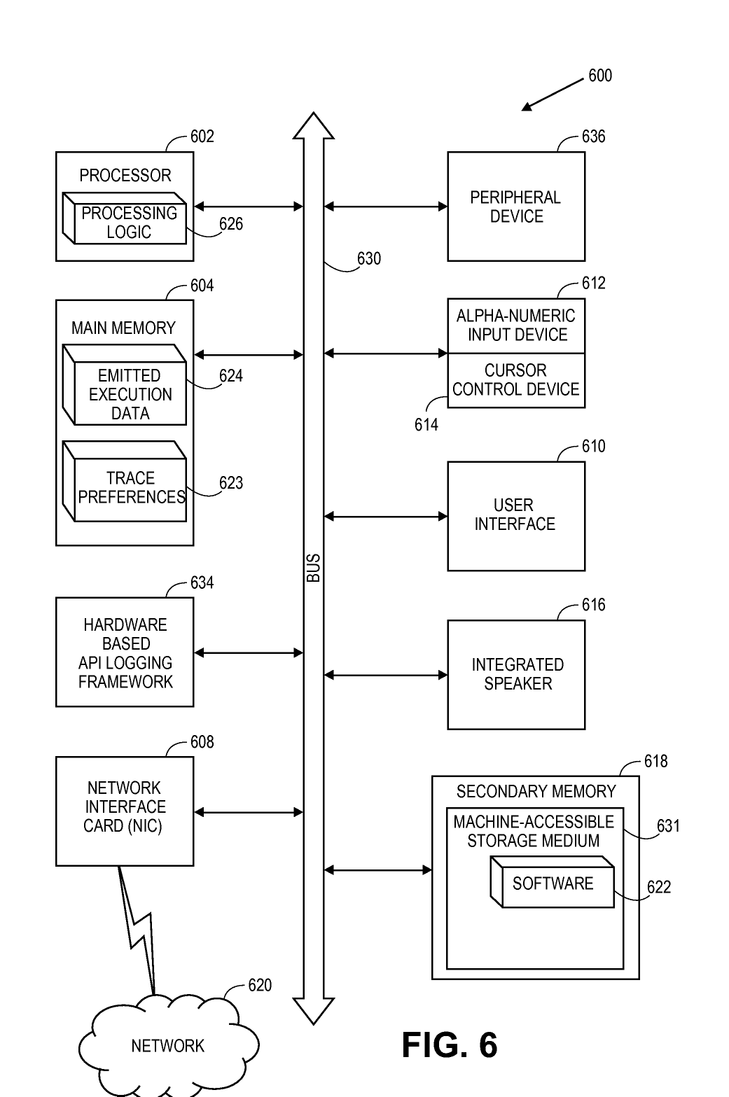

FIG. 6 illustrates a diagrammatic representation of a machine 600 in the exemplary form of a computer system, in accordance with one embodiment, within which a set of instructions, for causing the machine 600 to perform any one or more of the methodologies discussed herein, may be executed. In alternative embodiments, the machine may be connected (e.g., networked) to other machines in a Local Area Network (LAN), an intranet, an extranet, or the Internet.

The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 600 includes a processor 602, a main memory 604 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 618 (e.g., a persistent storage device including hard disk drives and persistent multi-tenant data base implementations), which communicate with each other via a bus 630. Main memory 604 includes emitted execution data 624 (e.g., data emitted by a logging framework) and one or more trace preferences 623 which operate in conjunction with processing logic 626 and processor 602 to perform the methodologies discussed herein.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like.

The computer system 600 may further include a network interface card 608. The computer system 600 also may include a user interface 610 (such as a video display unit, a liquid crystal display (LCD), or a cathode ray tube (CRT)), an alphanumeric input device 612 (e.g., a keyboard), a cursor control device 614 (e.g., a mouse), and a signal generation device 616 (e.g., an integrated speaker). The computer system 600 may further include peripheral device 636 (e.g., wireless or wired communication devices, memory devices, storage devices, audio processing devices, video processing devices, etc. The computer system 600 may further include a Hardware based API logging framework 634 capable of executing incoming requests for services and emitting execution data responsive to the fulfillment of such incoming requests.

The secondary memory 618 may include a machine-readable storage medium (or more specifically a machine-accessible storage medium) 631 on which is stored one or more sets of instructions (e.g., software 622) embodying any one or more of the methodologies or functions of dynamic adaptive configuration management database systems described herein. The software 622 may also reside, completely or at least partially, within the main memory 604 and/or within the processor 602 during execution thereof by the computer system 600, the main memory 604 and the processor 602 also constituting machine-readable storage media. The software 622 may further be transmitted or received over a network 620 via the network interface card 608. The machine-readable storage medium 631 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer -readable media, such as non-transitory computer -readable storage media (e.g., magnetic disks; optical disks; random access memory; read only memory; flash memory devices; phase-change memory).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

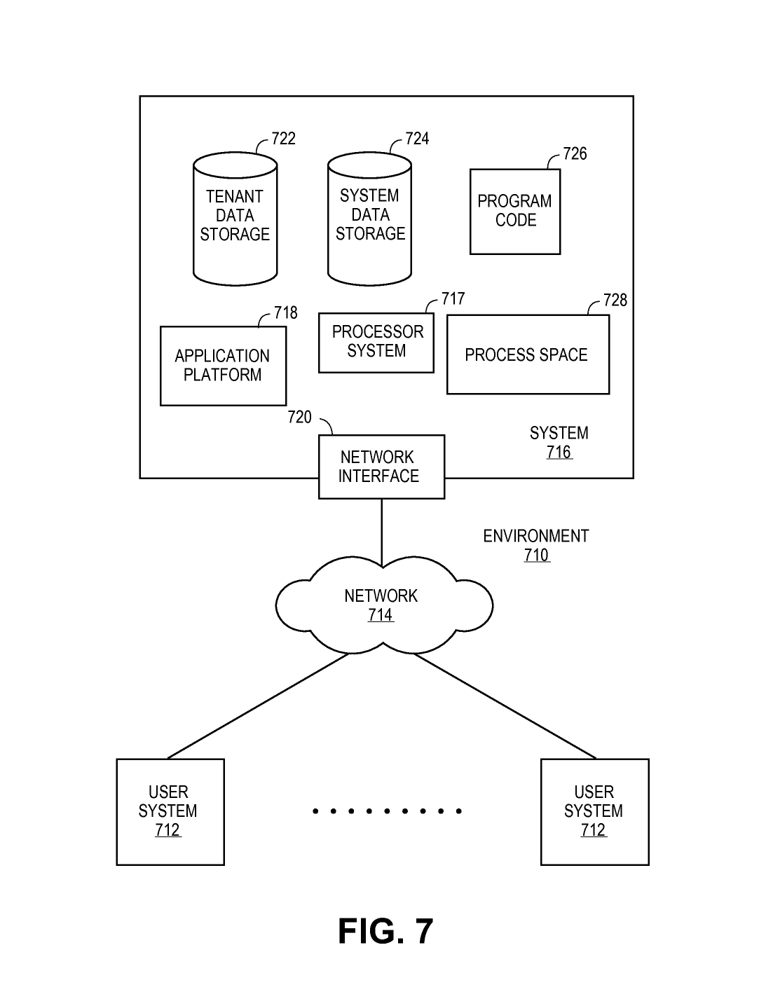

FIG. 7 illustrates a block diagram of an environment 710 wherein an on-demand database service might be used. Environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

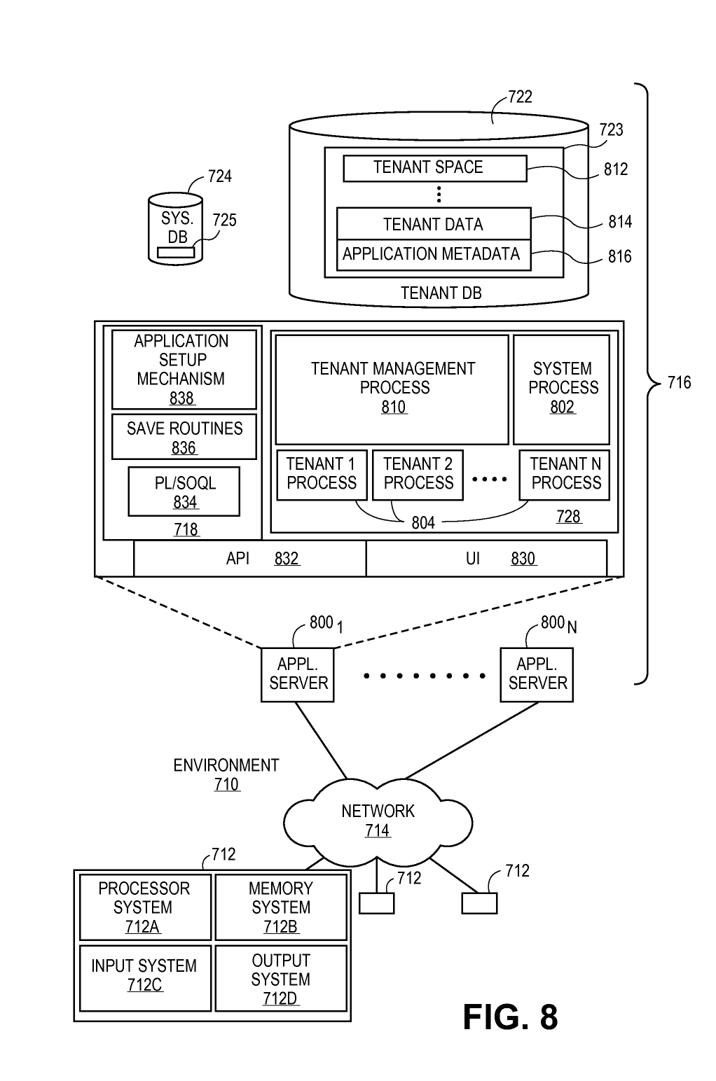

Environment 710 is an environment in which an on-demand database service exists. User system 712 may be any machine or system that is used by a user to access a database user system. For example, any of user systems 712 can be a handheld computing device, a mobile phone, a laptop computer, a work station, and/or a network of computing devices. As illustrated in herein FIG. 7 (and in more detail in FIG. 8) user systems 712 might interact via a network 714 with an on-demand database service, which is system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” will be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Pentium® processor or the like. Similarly, system 716 (and additional instances of an MTS, where more than one is present) and all of their components might be operator configurable using application(s) including computer code to run using a central processing unit such as processor system 717, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 also illustrates environment 710. However, in FIG. 8 elements of system 716 and various interconnections in an embodiment are further illustrated. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Program Interface (API) 832, PL/SOQL 834, save routines 836, application setup mechanism 838, applications servers 800₁-400_{N}, system process space 802, tenant process spaces 804, tenant management process space 810, tenant storage area 812, user storage 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage areas 812, which can be either a physical arrangement and/or a logical arrangement of data. Within each tenant storage area 812, user storage 814 and application metadata 816 might be similarly allocated for each user. For example, a copy of a user's most recently used (MRU) items might be stored to user storage 814. Similarly, a copy of MRU items for an entire organization that is a tenant might be stored to tenant storage area 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 800₁ might be coupled via the network 714 (e.g., the Internet), another application server 800_{N-1} might be coupled via a direct network link, and another application server 800N might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 Big-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method for providing information to allow a client sufficient to generate a graphical user interface to be displayed on a display device of an electronic system, the method comprising:
evaluating metametadata to determine features of a user interface, wherein the metametadata comprises properties of metadata corresponding to the user interface;
communicating the features to the client application so the client can generate the graphical user interface

2. The method of claim 1 wherein the information is tailored to a tenant of a multitenant database environment or a particular user within such a tenant.

3. The method of claim 1 further comprising:
associating the properties with existing object metadata; and
mapping the properties to original object metadata.

4. The method of claim 3 further comprising wrapping the properties to provide additional information.

5. The method of claim 3 further comprising wrapping the properties to override the information they provide.

6. An apparatus for providing a multitenant environment having custom fields and/or custom entities, the apparatus comprising:
means for evaluating metametadata to determine features of a user interface for creating, editing, or displaying metadata for a custom field or custom entity, wherein the metametadata comprises properties of metadata corresponding to elements of the user interface.

7. The apparatus of claim 6 further comprising:
means for associating the properties with existing object metadata; and
means for mapping the properties to original object metadata.

8. The apparatus of claim 6 further comprising means for wrapping the properties to provide additional information.

9. The method of claim 6 further comprising means for overriding the properties to provide new properties.

10. An article of manufacture comprising a computer-readable medium having stored thereon instructions for generating a graphical user interface to be displayed on a display device of an electronic system that, when executed by one or more processors, cause the one or more processors to:
evaluate metametadata to determine features of a user interface, wherein the metametadata comprises properties of metadata corresponding to the user interface;

11. The article of claim 10 wherein the information is tailored to a tenant of a multitenant database environment or a particular user within such a tenant.

12. The article of claim 10 further comprising instructions that, when executed, cause the one or more processors to:
associate the properties with existing object metadata; and
map the properties to original object metadata.

13. The article of claim 10 further comprising instructions that, when executed, cause the one or more processors to wrap the properties to provide additional information.

14. The article of claim 10 further comprising instructions that, when executed, cause the one or more processors to wrap the properties to override the information they provide.
